(19) United States
(12) Patent Application Publication
(10) Pub. No.: US 2005/0210169 A1
(43) Pub. Date: Sep. 22, 2005

(54) Portable exercise data management device

(76) Inventor: Ming-Fu Chou, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/019,162

(22) Filed: Dec. 23, 2004

(30) Foreign Application Priority Data
Mar. 17, 2004 (TW) 093204059

(51) Int. Cl. G06F 13/10

(52) U.S. Cl. 710/62

(57) ABSTRACT

A portable exercise data management device includes a panel with a plurality of control switches including a save/restore button connected to a top surface of the panel. A control circuit includes an MCU (Micro Control Unit) which controls an application program/sport information integrated system by operating the control switches. An EEprom is electrically connected to the MCU so as to save and store data. A USB input/output interface is electrically connected to the EEprom so as to input/output data to another device that is compatible to the exercise data management device.

### FIELD OF THE INVENTION

The present invention relates to a portable exercise data management device that stores data of the history records of the users and the data can be output via a USB to a personal computer or the like.

### BACKGROUND OF THE INVENTION

A conventional exerciser such as a treadmill “A” as disclosed in FIG. 1, and generally includes a control panel which includes control switches and a display unit. The users may set different molds of sport by using programs burned in the software of the control panel. The display unit displays the user's basic physic conditions such as pulses and calories to be burned, speed and time of the treadmill “A”. Nevertheless, these data is a temporary data and simply displayed during use of the treadmill “A” and cannot be stored or accumulated for reference in the future.

The present invention intends to provide a portable exercise data management device that may store history of records of exercise of the users and the data can be output to computers or the like to be analyzed.

### SUMMARY OF THE INVENTION

The present invention relates to a portable exercise data management device which comprises a panel for displaying pre-set data and has a plurality of control switches including a save/restore button. A control circuit includes an MCU (Micro Control Unit 212 which controls an application program/sport information integrated system by operating the control switches and an EEprom is electrically connected to the MCU so as to store data. A USB input/output interface is electrically connected to the EEprom and located on the panel so as to input/output data.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a treadmill having a conventional control panel;

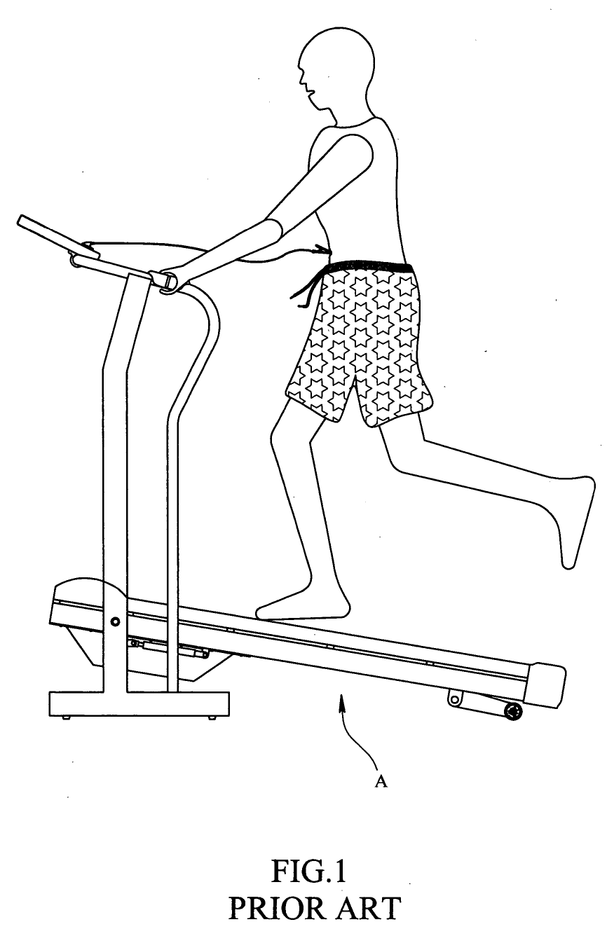

FIG. 2 shows the portable exercise data management device of the present invention;

FIG. 3 illustrates a diagram of the circuit of the portable exercise data management device of the present invention;

FIG. 4 shows the portable exercise data management device of the present invention can be connected with variety of process devices, and

FIG. 5 shows a treadmill having the portable exercise data management device of the present invention.

### DETAILED DESCRIPTION OF THE PREFERRED EMBODIMENT

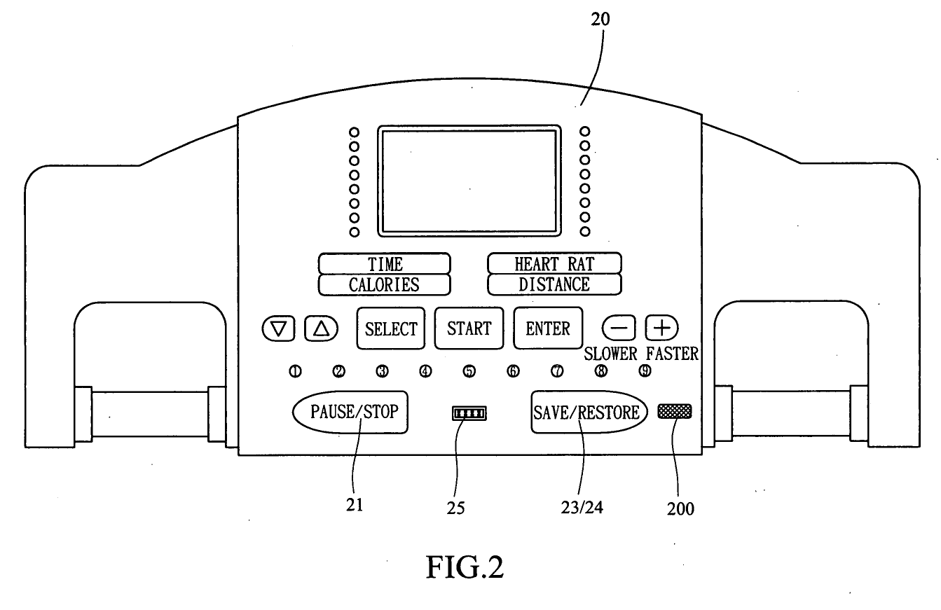

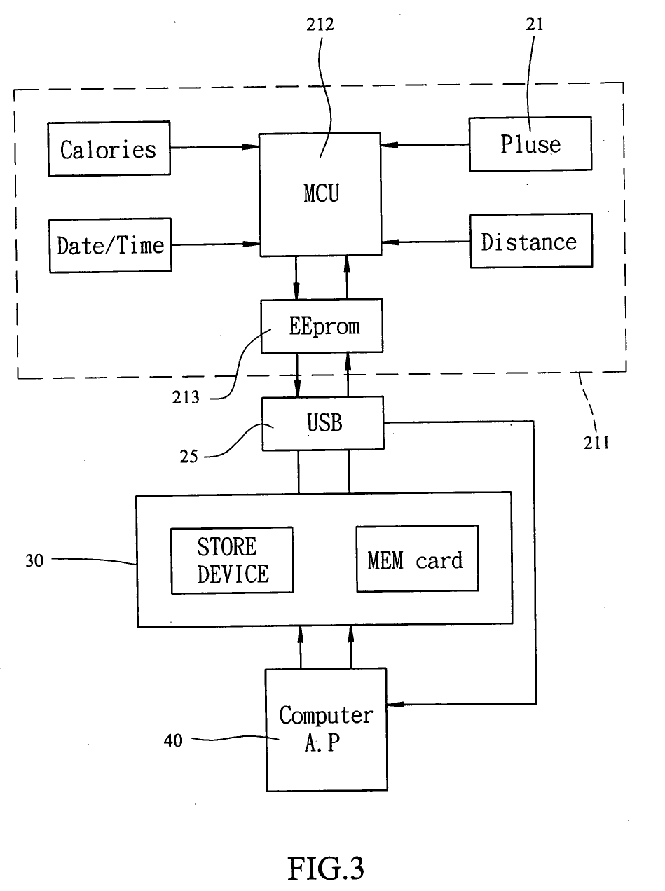

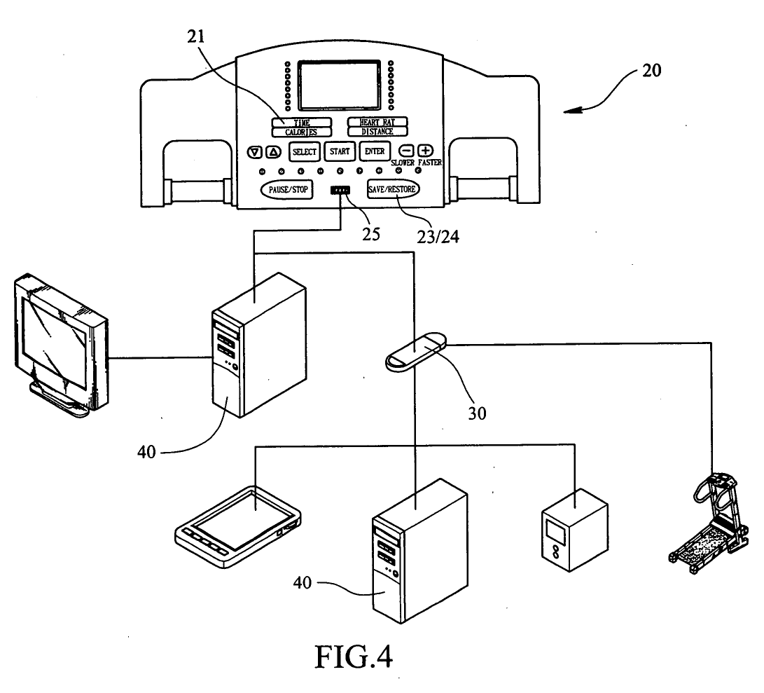

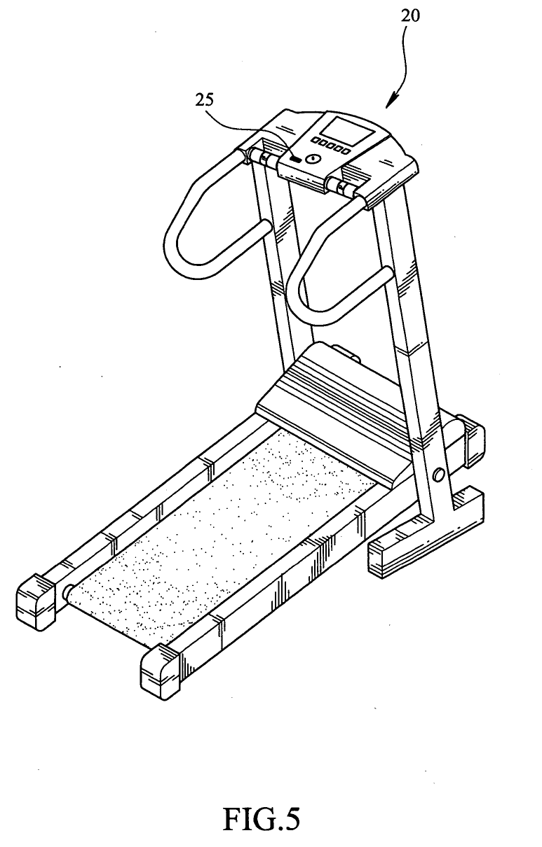

Referring to FIGS. 2 to 5, the portable exercise data management device of the present invention a panel 20 having a plurality of control switches such as pause/stop button 21, start button, select button, enter button, up-and-down button, left-and-right button, slower button, faster button and a save/restore button 23/24. A control circuit 211 is equipped in the device and includes an MCU (Micro Control Unit) 212 which controls an application program/sport information integrated system by operating the control switches. An EEprom 213 is electrically connected to the MCU 212 so as to store data. A USB input/output interface 25 is electrically connected to the EEprom 213 and located on the panel 20 so as to input/output data.

The data includes user's identification, calories burned, date, time, pulse, and distance of running. These data is basic and can be increased or reduced as desired. The data is formatted to be compatible to personal computers 40, PDAs, memory cards, and flash disks 30. An infra red transmission/receiving device 200 can be optionally equipped to the device so as to conveniently send the data to another process device such as a personal computer 40 that is compatible to the device. The data can be formatted so as to be easily edited and processed.

The data in the device can be portable with the user so that the user knows the history records of the physical conditions of his or her own. The data can also be sent to another computer or the like to be analyzed.

While we have shown and described the embodiment in accordance with the present invention, it should be clear to those skilled in the art that further embodiments may be made without departing from the scope of the present invention.

1. A portable exercise data management device comprising:
a panel having a plurality of control switches including a save/restore button;
a control circuit including an MCU (Micro Control Unit) which controls an application program/sport information integrated system by operating the control switches, an EEprom electrically connected to the MCU so as to store data, a USB input/output interface electrically connected to the EEprom and located on the panel so as to input/output data.

2. The device as claimed in claim 1, wherein the data includes user's identification, calories burned, date, time, pulse, and distance of running.

3. The device as claimed in claim 1, wherein the data is formatted to be compatible to personal computers, PDAs, memory cards, and flash disks.

4. The device as claimed in claim 1 further comprising an infra red transmission/receiving device.
